(19) United States
(12) Patent Application Publication
(10) Pub. No.: US 2025/0043389 A1
(43) Pub. Date: Feb. 6, 2025

(54) RECOVERING GOLD

(71) Applicant: NEWCREST MINING LIMITED, Melbourne (AU)

(72) Inventors: David SEAMAN, Melbourne (AU); Luke VOLLERT, Melbourne (AU); William FUTCHER, Melbourne (AU); John O'CALLAGHAN, Melbourne (AU)

(21) Appl. No.: 18/719,600

(22) PCT Filed: Dec. 16, 2022
(86) PCT No.: PCT/AU2022/051519

§ 371 Date: Jun. 13, 2024

(30) Foreign Application Priority Data
Dec. 17, 2021 (AU) 2021904110

(51) Int. Cl. C22B 11/08; B03D 1/08; C22B 1/24

(52) U.S. Cl. CPC C22B 11/08; B03D 1/087; C22B 1/24; B03D 2203/025

(57) ABSTRACT

A method of recovering free milling gold from a gold-containing feed material that includes processing at least a part of a tailings stream from a flotation element in a size separation element and producing a fines stream and a coarse stream. The method also includes recovering free milling gold from at least one of the fines stream and the coarse stream.

### CROSS REFERENCES TO RELATED APPLICATIONS

This application is a national-stage application under 35 U.S.C. § 371 of International Application No. PCT/AU2022/051519, filed Dec. 16, 2022, which International Application claims benefit of priority to Australian Patent Application No. 2021904110, filed Dec. 17, 2021.

### TECHNICAL FIELD

The invention relates to recovering at least a portion of gold in mined ore that can be described as being “free milling” gold.

The invention relates particularly to recovering free milling gold from tailings from a flotation element that has processed a crushed and ground feed material derived from a gold-containing ore.

### BACKGROUND

Cyanide is a widely used lixiviant option for recovering gold in gold-containing ores. Typically, sodium cyanide (NaCN) is added to a slurry of gold-containing particles produced in a mineral processing plant and the cyanide ion forms a soluble complex ion, [Au(CN)₂]⁻ with gold. Gold is recovered from solution in downstream process steps.

### SUMMARY

The applicant has developed a process for recovering free milling gold from a gold-containing feed material, such as a feed material derived from a gold-containing ore, that makes it possible to recover larger concentrations of free milling gold, for example that is cyanide soluble gold, than is currently the case with processes used by the applicant.

The invention is based on a finding of the applicant that, in some ore bodies, free milling gold in ore deports preferentially to particular size fractions and therefore size separation of flotation tails can be an effective way of reducing the amounts of tails that are taken to leach recovery of cyanide-soluble gold, with lower infrastructure costs than would otherwise be the case.

The invention provides in general terms a method of recovering free milling gold from a gold-containing feed material that includes processing at least a part of a tailings stream from a flotation element in a size separation element and producing a fines stream and a coarse stream and recovering free milling gold from at least one of the fines stream and the coarse stream.

The invention provides in more particular terms a method of recovering free milling gold from a gold-containing feed material, such as a feed material derived from a gold-containing ore, that includes the steps of:
(a) passing a feed stream of the feed material through a flotation element and producing (i) a concentrate stream and (ii) a tailings stream;
(b) processing at least a part of the tailings stream in a size separation element, such as a cyclone, and producing a fines stream and a coarse stream; and
(c) recovering free milling gold from at least one of the fines stream and the coarse stream.

The invention provides in more particular terms a method of recovering free milling gold from a gold-containing feed material, such as a feed material derived from a gold-containing ore, that includes the steps of:
(a) processing a feed material containing free milling gold in a flotation element and producing (i) a concentrate stream and (ii) a tailings stream;
(b) processing at least a part of the tailings stream in a size separation element and producing a fines stream and a coarse stream, with a threshold particle size below which particles are in the fines stream and above which particles are in the coarse stream being selected so that a substantial amount of free milling gold in the processed tailings stream is in the fines stream or the coarse stream; and
(c) recovering free milling gold from at least one of the fines stream and the coarse stream, for example subject to the amount of free milling gold in the streams.

It is noted that, in practice, there will not be a hard cut-off at a selected threshold particle size, due to limitations in available equipment options to do this.

Typically, there will be a small percentage of larger sized particles than the threshold particle size in the fines stream.

More particularly, there may be up to 20%, typically up to 15%, and more typically up to 10% by weight of particles that are larger in size than the threshold particle size in the fines stream.

In addition, or alternatively, typically there will be a small percentage of smaller sized particles than the threshold particle size in the coarse stream.

In addition, or alternatively, there may be up to 20%, typically up to 15%, and more typically up to 10% by weight of particles that are smaller in size than the threshold particle size is in the coarse stream.

It is also noted that the method may include adjusting the threshold particle size during the course of the method, guided by measurements made on the concentrations of free milling gold, for example that is cyanide soluble gold, in the fines stream and the coarse stream.

The method may include adjusting the threshold particle size during the course of the method due to changing downstream constraints on equipment capacities.

The threshold particle size may be any suitable particle size for a given mine, based on a range of factors, including by way of example, mineralogy of a mine and mineral processing plant operating conditions, including crushing and grinding and flotation circuits.

The above-mentioned “substantial amount of free milling gold” in the processed tailings stream that is in the fines stream or in the coarse stream may be at least 55 wt. %, typically at least 60 wt. %, more typically at least 65 wt. %, of the total of the free milling gold in the processed tailings stream.

The term “size separation element” is understood herein to mean any element that can separate a tailings stream into at least two streams based on the size of particles in the tailings stream, with one stream being the fines stream with particles below the threshold particle size and the other stream being the coarse stream with particles above the threshold particle size.

It is noted that in a number of instances, size separation elements separate a feed stream on the basis of size and density. These elements are regarded as size separation elements.

Cyclones are one size separation option.

Other size separation options include screens, classifiers and jigs.

The flotation element may be any suitable element.

The method may include recovering free milling gold from the fines stream.

In one embodiment, the method may include processing the coarse stream produced in size separation step (b) in another optional size separation element and producing a fines stream and a coarse stream.

The method may include recovering free milling gold from the fines stream from the other fines separation element.

The method may include processing the coarse stream from the other optional fines separation element in a coarse flotation element and producing a coarse concentrate stream and a tailings stream.

The method may include grinding the coarse concentrate stream and producing a ground concentrate stream.

The method may include processing the ground concentrate stream in a cleaner element and producing (i) another concentrate stream and (ii) a tailings stream.

The method may include recovering gold from the other concentrate stream.

In another embodiment, the method may include processing the coarse stream produced in size separation step (b) in a re-grind circuit and a single stage cleaning circuit and producing another concentrate stream.

The method may include recovering gold from the other concentrate stream.

Step (c) may include recovering free milling gold from at least one of the fines stream and the coarse stream by leaching the stream with a lixiviant and taking free milling gold into solution.

Step (c) may further include recovering free milling gold from solution.

The lixiviant may be any one of cyanide, thiosulfate, thiourea, and glycine or any other suitable lixiviant.

Typically, the lixiviant is cyanide.

The gold-containing ore may be any deposit that contains free milling gold.

By way of example, the gold-bearing ore may be a low-grade porphyry style copper-gold deposit, which typically has gold concentrations of less than 1 g/t.

Typically, the gold-containing ore may include gold in other forms, such as gold in refractory sulphide minerals.

The amounts of different forms of gold in mined ore varies considerably between mines. For example, 85 wt. % of the gold in the ore in the Telfer mine of the applicant is free milling gold and 30 wt. % of the gold in the ore in the Lihir mine of the applicant is free milling gold.

Typically, the feed material to flotation step (a) is a mined (which term includes mined and stockpiled) gold-containing ore that has been crushed and ground to a suitable particle size distribution for the flotation element.

Therefore, the method may include crushing and grinding a mined gold-containing ore and producing the feed material.

The method may include recovering gold from the concentrate stream from the flotation element.

Any suitable step or steps may be used to recover gold from the concentrate stream and the above-described other concentrate stream.

By way of example, the method may include
(a) processing the concentrate stream or the other concentrate stream in an oxidation unit, such as autoclaves; and
(b) processing an output stream of the oxidation unit in a leaching circuit, such as a cyanide leach circuit.

The method may include transferring a part of the tailings stream to the oxidation unit and processing the tailings stream in the oxidation unit.

The method may include processing the tailings stream in a thickener unit and transferring an output stream from the thickener unit to the oxidation unit.

The invention also includes a plant for recovering free milling gold from a gold-containing feed material, such as a feed material derived from a gold-containing ore, that includes:
(a) a flotation element, for producing (i) a concentrate stream and (ii) a tailings stream from a feed material; and
(b) a size separation element for processing the tailings stream and producing a fines stream and a coarse stream; and
(c) a recovery unit for recovering free milling gold from at least one of the fines stream and the coarse stream.

The plant may include a comminution circuit, such as a crushing and grinding circuit, for producing the feed material for the flotation element.

Cyclones are one size separation option.

Other size separation options include screens, classifiers and jigs.

In one embodiment, the plant may include another size separation element for processing the coarse stream from size separation element (b) and producing a fines stream and a coarse stream.

The plant may include a coarse flotation element for processing the coarse stream from the other size separation element and producing a coarse concentrate stream and a tailings stream.

The plant may include a regrind element and a cleaner element for producing a ground coarse concentrate.

In another embodiment, plant may include a re-grind circuit and a single stage cleaning circuit for producing another concentrate stream.

### BRIEF DESCRIPTION OF THE DRAWINGS

The invention is described further below by way of example only with reference to the accompanying drawings, of which:

FIG. 1 is a flow sheet of one embodiment of a method and an apparatus of recovering gold from a gold-containing ore in accordance with the invention;

FIG. 2 is a flow sheet of another, although not the only other, embodiment of a method and apparatus of recovering gold from a gold-containing ore in accordance with the invention;

FIG. 3 is a flow sheet of another, although not the only other, embodiment of a method and apparatus of recovering gold from a gold-containing ore in accordance with the invention;

FIG. 4 provides particle size distribution data for material from HGO and FGO grinding circuits collected in confidential performance testing of the invention carried out in a plant of the applicant;

FIG. 5 is a cyanide soluble gold distribution for material from the HGO and FGO grinding circuits in the plant;

FIG. 6 is a cyanide soluble gold distribution for material from the FGO grinding circuit in the plant; and

FIG. 7 is graphs of bottle roll kinetic data generated in the plant.

### DESCRIPTION OF EMBODIMENTS

The term “free milling” in the context of gold is understood herein to mean gold that can be recovered from mined ore without roasting or other chemical treatment of the ore.

In general, “free milling” gold is gold that can be leached from mined ore via a lixiviant, such as cyanide. One definition of “free milling” gold in a text entitled “The Chemistry of Gold Extraction” by John. O. Marsden (Iain House SME, 2006) is that “free milling” gold is “gold in ore that is sized 80%<75 μm from which cyanidation can extract 90% of the gold, and has not sustained high reagent consumption”. Usually, leaching is carried out on mined ore that has been crushed and ground, and optionally formed into agglomerates, of a suitable size for effective leaching. Therefore, the above references to “mined ore” includes ore that has been processed in this way.

In general, “free milling” gold is gold that is not regarded as “refractory” gold in ore.

The term “free milling” gold also includes gold that is not free milling in mined ore but becomes free milling by natural processes, such as by exposure of stockpiled ore to the atmosphere, including in situ oxidation of stockpiled ore.

The term “free milling” does not include gold that becomes free milling as a consequence of treatment of mined ore. For example, refractory gold that has been roasted and becomes free milling as a consequence of roasting is not within the definition of “free milling” in the specification.

The term “lixiviant” is understood herein to mean a liquid medium that selectively extracts a desired metal from ore (or ore that has been crushed and ground and optionally agglomerated) to be leached, and from which the desired metal can then be recovered in a concentrated form.

Typically, in the context of the invention, the lixiviant includes cyanide, thiosulfate, thiourea, and glycine.

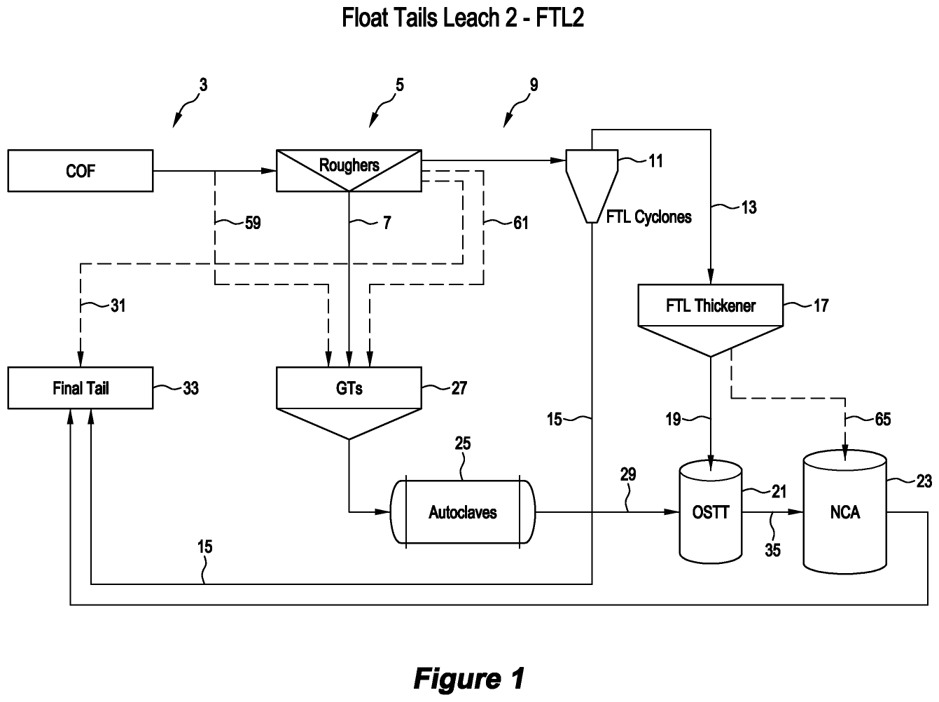

The embodiments of the method and apparatus of the invention shown in FIGS. 1-3 are described in the context of recovering free milling gold from a gold-containing material in the form of sulphide minerals in a gold-containing sulphide ore, with the gold being in a number of different forms including free milling gold and gold in refractory sulphide minerals.

The invention is not limited to this ore type.

The embodiments of the method and apparatus of the invention shown in FIGS. 1-3 are described in the context of the use of cyanide as a lixiviant for leaching free milling gold from fines streams and/or coarse streams produced in the embodiments.

The invention is not limited to the use of cyanide as a lixiviant.

### Overview of FIGS. 1-3

FIGS. 1-3 are flow sheets for processing mined ore that contains free milling gold and refractory gold that has been crushed and ground and is supplied as a feed material 3 to the flow sheets.

The invention is not confined to these flow sheets.

The mining and processing steps to form the crushed and ground material as the feed material 3 in the flow sheets are not part of the invention. These steps are described by way of example below to provide context for the invention within a plant within a mine.

In addition, the invention is not confined to a number of the processing steps, such as pressure oxidation in autoclaves, shown in FIGS. 1-3. These steps are included in the Figures to provide context for the invention within a plant within a mine.

The following description of processing steps to form a feed material 3 for each of the flow sheets in FIGS. 1-3 is by way of illustration only.

The processing steps are as follows.
Multiple crushing steps process run of mine (ROM) ore and produce crushed ore.
Crushed ore is transferred to and processed in multiple grinding steps and produce the feed material 3 with a desired particle size distribution for flotation.
The crushing steps are carried out using a combination of crushers, such as a combination of gyratory, cone and HPGR crushers (not shown).
The grinding steps are carried out, for example, in a SAG mill as a primary mill unit (not shown).
The grinding steps also include ball mills as secondary mills (not shown), with the SAG mill and the ball mills operating in a closed circuit.
At least a part of the output stream of the secondary mills is the feed material 3 shown in FIGS. 1-3.
The feed material 3 is a slurry that typically contains 30-40 wt. % solid particles but may contain any suitable solids loading. The invention is not confined to this solids loading range.

The plant may include recovery options (not shown) such as flash flotation or gravity gold recovery that are not shown in FIGS. 1-3.

### FIG. 1 Embodiment

With reference to the FIG. 1, the crushed and ground feed material 3 is supplied to a flotation circuit 5 and processed in the circuit 5, producing a concentrate stream 7 and a tailings stream 9.

Optionally, the crushed and ground feed material 3 is supplied to grind thickeners 27. This is shown by the dotted line 59. The thickened material is then supplied to oxidation units in the form of autoclaves 25 and other below-described processing steps.

Operationally, the amount of the crushed and ground material 3 sent to the flotation circuit 5 or sent directly to the grind thickeners 27 and then to autoclaves 25 for oxidation is varied depending on a number of factors.

Typically, flotation is applied to 60% of the crushed and ground feed material 3. This fraction is varied depending on the dynamic requirements of the process in order to maximise the amount of material treated in the oxidation circuit. Typically, flotation is used to maximise the total plant throughput given the different crushing and grinding circuit and autoclave capacities. Operationally, autoclaves 25 are always kept at capacity as they are a process bottle neck.

The split of the feed material 3 that is sent to flotation 5 or to the grind thickeners 27 is achieved by either a variable pumping arrangement of the feed material 3 or binary selection by way of valving.

The flotation circuit 5 may be any suitable flotation element.

The flotation circuit 5 is operated to float valuable gold-containing particles, and these particles form the concentrate stream 7. The flotation circuit 5 also produces the above-mentioned tailings stream 9.

It is noted that, typically, the concentrate stream 7 is finer than the tailings stream 9 but can and does contain coarse particles.

The tailings stream 9 contains fine particles and coarse particles. These particles contain cyanide soluble, free milling gold.

The tailings stream 9 is transferred to and processed in a cyclone 11 (which may be a series of interconnected cyclones). The particles in the tailings stream 9 are separated based on size into a fines tailings stream 13 and a coarse tailings stream 15.

The coarse tailings stream 15 becomes a final tails stream 33.

The size separation is based on selecting a threshold value between “fine” and “coarse” sized particles that results in a higher concentration of free milling gold being in one of the two streams.

As noted above, the applicant has found that that, in some ore bodies, free milling gold deports preferentially to particular size fractions and therefore size separation of flotation tailings can be an effective way of reducing the amounts of tails that are taken to leach recovery of free milling gold—this reduces infrastructure and operating costs.

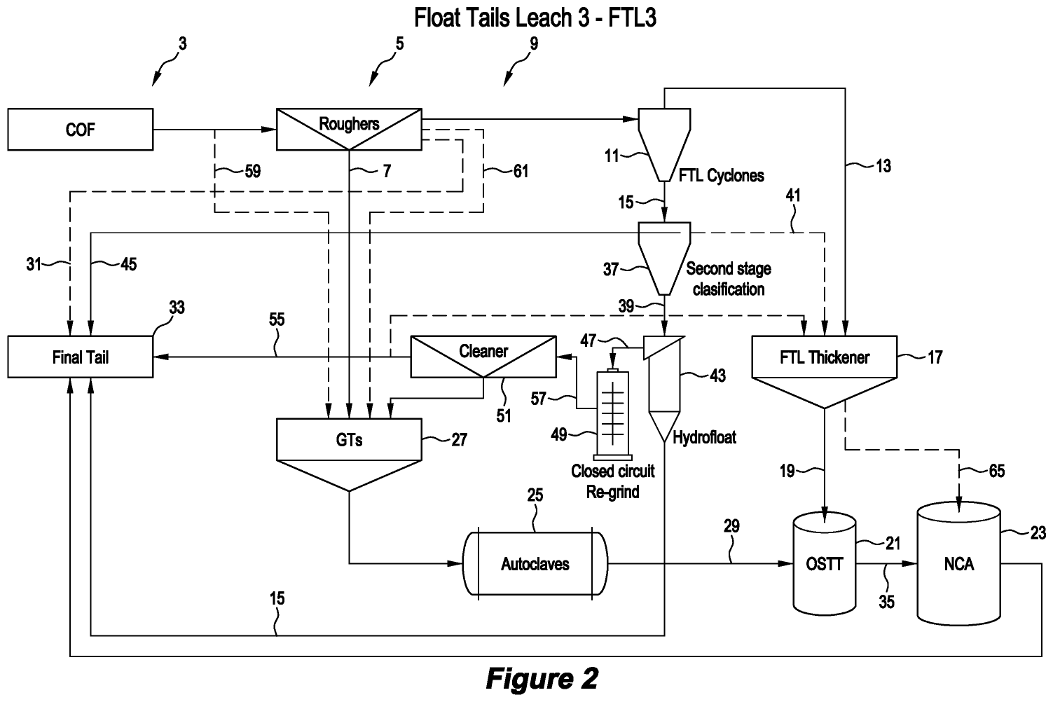

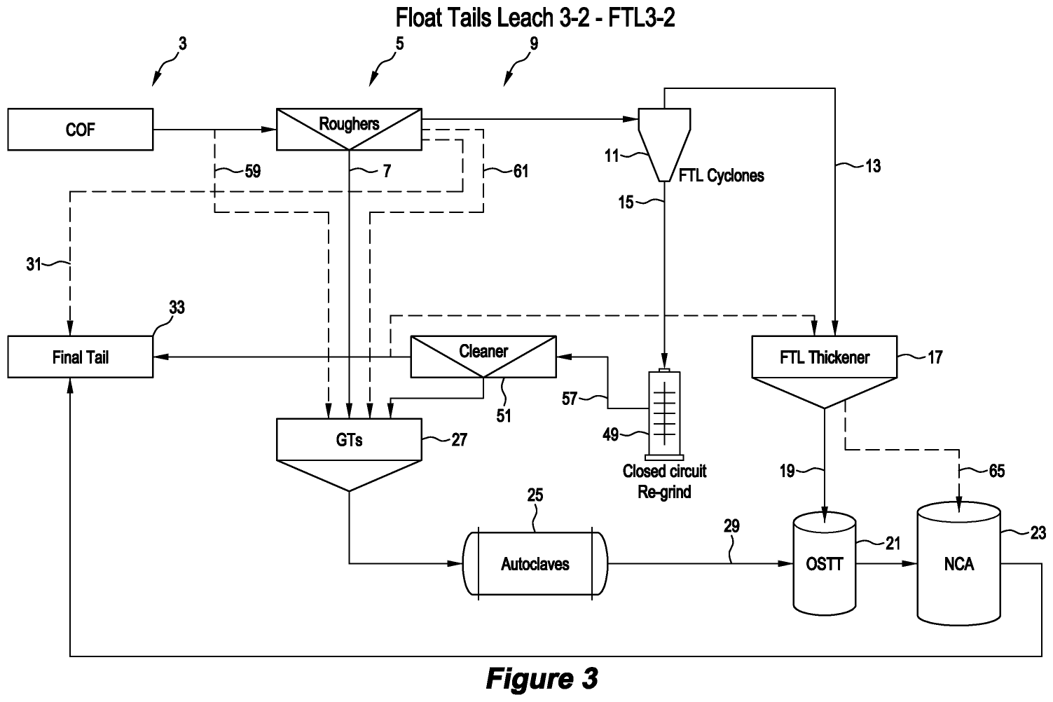

In the flow sheet of FIG. 1 (and also FIGS. 2 and 3), the selected threshold value results in a higher concentration of free milling gold being in the fines tailings stream 13. The invention is not confined to this outcome and the higher concentration may be in a coarse stream.

The fines tailings stream 13 is transferred to and processed in a thickener 17.

A thickened fines tailings stream 19 is then transferred to and processed in an oxidised slurry transfer tank 21.

Finally, the thickened fines tailings stream 19 is transferred as a stream 35 from the oxidised slurry transfer tank (OSTT) 21 and processed in a cyanide leach circuit 23 and cyanide soluble free milling gold is taken into solution in the leach circuit. Gold is then recovered from solution by any suitable recovery option (not shown), such as solvent extraction and electrowinning gold onto cathodes. It is noted that the invention is not confined to cyanide as a lixiviant.

The concentrate stream 7 from the flotation circuit 5 is transferred to the autoclaves 25 via the grind thickeners 27 and gold containing sulfides in the concentrate stream 7 are oxidised to a form that is suitable for recovery in the cyanide leach circuit 23.

The slurry 29 discharged from the autoclaves 25 is transferred to the cyanide leach circuit 23 via the OSTT 21 and processed as described above.

It can be appreciated from FIG. 1 that the size separation in the cyclones 11 makes it possible to select a process stream containing free milling gold for processing in downstream gold recovery steps from a larger input feed stream, thereby increasing the overall gold recovery from the mine.

The flow sheet also includes taking (a) an optional split 31 of the tailings stream 9 from the flotation circuit 5 to the final tails stream 33 and (b) an optional split 61 of the tailings stream 9 from the flotation circuit 5 to grind thickeners 27 and then to the autoclaves 25, whereby only a part of the tailings stream 9 is transferred to and processed in the cyclone 11.

A decision on whether to split the tailings stream 9 depends in any situation on operating conditions in the plant at that time.

By way of example, the optional split 61 of a part of the tailings stream 9 from the flotation circuit 5 to the autoclaves 25 via the grind thickener 27 makes it possible to achieve effective redirection of milled product to flotation or oxidation without the need to incur losses from frequent start-ups and shutdowns of the flotation circuit 5, in the event that this is necessary.

The flow sheet also includes taking an optional split 65 of the thickened fines tailings stream 19 directly to the cyanide leach circuit 23. This may be appropriate given operational conditions in the cyanide leach circuit 23.

### FIG. 2 Embodiment

The FIG. 2 embodiment is very similar to the FIG. 1 embodiment and the same reference numerals are used to describe the same features in each flow sheet.

The main difference between the flow sheets is the processing steps for the coarse stream 15 from the cyclone 11 in FIG. 2.

The purpose of these processing steps is to facilitate recovering free milling gold from the coarse stream 15.

With reference to FIG. 2, the coarse stream 15 is transferred to and optionally processed in a second cyclone 37 (or other options such as an Eriez Crossflow unit) to remove residual fine (i.e. <100 μm) material from the coarse stream 15.

The second stage of classification in the second cyclone 37 concentrates free milling gold that is in fines in the coarse stream 15 into an overflow stream 41 which is transferred to the thickener 17. Alternatively, depending on operating conditions, the overflow from the second cyclone 37 may be transferred to and becomes part of the final tails stream 33.

The remaining gold in the fines-deficient underflow stream 39 from the second cyclone 37 tends to be hosted in pyrite that requires oxidation to facilitate releasing gold. The pyrite tends to be in coarser particles.

The fines-deficient underflow stream 39 from the second cyclone 37 is transferred to and processed in a coarse flotation circuit 41, such as an Eriez Hydrofloat circuit, that produces (a) a coarse concentrate stream 47 that includes gold-containing particles and (b) a tailings stream 57.

The tailings stream 57 is transferred to and becomes part of the final tails stream 33.

The coarse concentrate stream 47 that includes gold-containing particles is relatively low grade due to poor liberation. As a result, the coarse concentrate stream 47 is re-ground in a circuit 49 and processed in a single stage cleaning circuit 51 and the grind thickener 27 upstream of oxidation in the autoclave 25.

### FIG. 3 Embodiment

The FIG. 3 embodiment is very similar to the FIGS. 1 and 2 embodiments and the same reference numerals are used to describe the same features in each flow sheet.

The main difference between the flow sheets of FIGS. 2 and 3 is that the FIG. 3 flow sheet:
(a) processes the coarse stream 15 from the cyclone 11 in a re-grind circuit 49 and a single stage cleaning circuit 51 before transferring the resultant concentrate stream to the autoclave 25; and
(b) does not include the second cyclone 37 and the coarse flotation unit 41 that are part of the FIG. 2 flow sheet.

### EXAMPLES

### Example 1

### Performance Testing

The applicant carried out confidential performance testing of the embodiment of the invention shown in FIG. 1 at its Lihir mine in PNG.

At the Lihir mine, ore is crushed in two primary crushing circuits, and the crushed ore is processed in three grinding circuits, named the HGO2, HGO and FGO circuits.

Crushed and ground material from the HGO2 circuit is transferred to pressure oxidation autoclaves and processed in the autoclaves.

Crushed and ground material from the HGO and FGO circuits is transferred to flotation circuits and processed in these circuits, and the concentrates are processed in the autoclaves.

The three grinding circuits have primary SAG mills followed by grinding mills in closed circuits with classifying hydrocyclones. Pebbles from the HGO and HGO2 circuits are combined and directed to two cone pebble crushers. Crushed pebbles are directed back to the HGO and HGO2 mills.

The confidential performance testing was carried out on feed material from the HGO and FGO grinding circuits. The crushed and ground material from these circuits was processed in flotation circuits with the flotation tail then processed through cyclone packs that were installed at Lihir.

Collectively, the flotation circuits and the cyclone packs are referred to below as the “HGO and FGO circuits”.

These circuits represent the section of the FIG. 1 embodiment that comprises supplying crushed and ground feed material 3 to the flotation circuit 5 and the cyclone 11. The HGO circuit operated with the optional split 61 of the tailings stream 9 from the flotation circuit 5 shown in FIG. 1, whereby only a part of the tailings stream 9 was transferred to and processed in the cyclone 11. The FGO circuit operated with 100% of the tailings stream 9 being transferred to the cyclone 11.

Seven surveys in total were performed during the confidential performance testing work to assess operation of an embodiment of the invention, four on the HGO feed material and three on the FGO feed material.

All samples collected in the surveys were filter pressed on site and shipped to the AMML Laboratory in Gosford, New South Wales, for processing. The following tests performed on each sample:
Head assay for gold, sulphide sulphur, total sulphur and inorganic carbon.
Size by Assay for gold, sulphide sulphur, total sulphur and inorganic carbon.
Bottle roll to determine cyanide soluble gold.
Leach residue size by assay for gold, sulphide sulphur, total sulphur and inorganic carbon.

The results of the analysis of samples is discussed below.

### Mass Balance and Laboratory Test Work Results

PI data for each of the survey periods was collected and incorporated with the test work data produced by AMML.

JKSimMet was used to create circuit mass, water, gold, sulphide sulphur and cyanide soluble gold balances.

The extracted PI data displayed some significant inconsistencies with regard to flows due to calibration drift on flow meters and density gauges.

PI reported values for flotation feed tonnages were cross checked against the daily balanced data to check PI data integrity. Where there was a significant discrepancy, SAG feed tonnages were used to determine approximations of the flotation feed rates.

Flotation tail and concentrate mass flow data extracted from PI showed poor reconciliation to the flotation feed data with calculated concentrate mass recoveries regularly being greater than 80%.

As a result, assay data was used to calculate mass recovery to the flotation concentrates, with calculated values agreeing well with the reported daily balanced flotation mass recoveries. HGO and FGO average mass balance results are tabulated in Table 1 and Table 2 below.

TABLE 1
HGO circuit mass balance

| | | | | Float Tail | | | | Final |
|---|---|---|---|---|---|---|---|---|
| | Float | Float | Float | Split to | CYC | FTL | FTL | Float |
| HGO Circuit | Feed | Con | Tail | Final Tail | Feed | COF | CUF | Tail |
| tph | 1525 | 570 | 954 | 478 | 476 | 188 | 287 | 766 |
| Mass Dist. | 100% | 37% | 63% | 31% | 31% | 12% | 19% | 50% |
| P80 | 171 | 129 | 198 | 202 | 193 | 43 | 234 | 218 |
| Au g/t | 2.40 | 5.25 | 0.73 | 0.74 | 0.72 | 0.95 | 0.56 | 0.68 |
| CN sol Au g/t | 1.09 | 1.60 | 0.39 | 0.38 | 0.41 | 0.73 | 0.25 | 0.33 |
| % CN sol Au | 42.2 | 30.5 | 53.9 | 51.0 | 56.9 | 77.1 | 44.0 | 48.3 |
| S2- | 3.90 | 9.48 | 0.60 | 0.62 | 0.59 | 0.31 | 0.78 | 0.68 |
| Au Dist Relative | 100.0% | 80.8% | 19.2% | 9.8% | 9.5% | 4.9% | 4.5% | 14.3% |
| to Float Feed | | | | | | | | |
| CN Sol Dist. | 100.0% | 24.8% | 75.2% | 35.4% | 39.8% | 21.6% | 18.2% | 53.6% |
| S2- Dist. | 100.0% | 90.6% | 9.4% | 4.7% | 4.7% | 0.9% | 3.7% | 8.5% |

TABLE 2
FGO circuit mass balance

| | | | | | | | Final |
|---|---|---|---|---|---|---|---|
| | Float | Float | Float | CYC | FTL | FTL | Float |
| FGO Circuit | Feed | Con | Tail | Feed | COF | CUF | Tail |
| tph | 593 | 179 | 414 | 414 | 198 | 217 | 217 |
| Mass Dist. | 100% | 30% | 70% | 70% | 33% | 37% | 37% |
| P80 | 144 | 110 | 158 | 158 | 41 | 214 | 214 |
| Au g/t | 2.16 | 5.81 | 0.59 | 0.59 | 0.74 | 0.47 | 0.47 |
| CN sol Au g/t | 1.00 | 2.11 | 0.30 | 0.30 | 0.52 | 0.15 | 0.15 |
| % CN sol Au | 46.4 | 36.4 | 50.7 | 50.7 | 70.8 | 32.1 | 32.1 |
| S2- | 4.27 | 12.61 | 0.67 | 0.67 | 0.46 | 0.87 | 0.87 |
| Au Dist Relative | 100.0% | 80.8 | 19.2% | 19.2% | 11.4% | 7.8% | 7.8% |
| to Float Feed | | | | | | | |
| CN Sol Dist. | 100.0% | 23.4% | 76.6% | 76.6% | 51.6% | 25.0% | 25.0% |
| S2- Dist. | 100.0% | 89.8% | 10.2% | 10.2% | 3.4% | 6.8% | 6.8% |

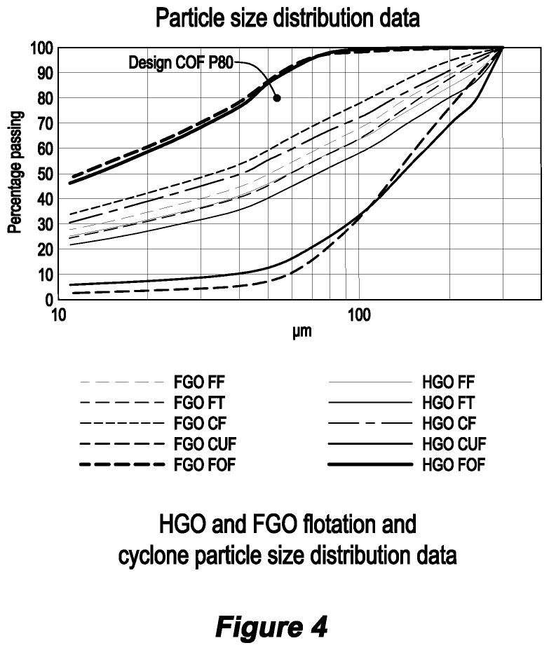

Particle size distribution data for the HGO and FGO circuits is shown in FIG. 4.

It is evident from FIG. 4 that the cyclone overflow particle size distributions for the HGO and FGO circuits are very similar, although they were slightly finer than the design specification. The mass of the cyclone feed reporting to the overflow was 40% and 48% for the HGO and FGO circuits respectively.

The cyclone underflows showed a very low fines content with only ˜11% of the stream being less than 53 μm, representing 15% of the total fines contained in the cyclone feeds. The majority of the fines reporting to the cyclone underflow were a function of water recovery.

Approximately 37% of the cyanide soluble gold in the flotation tailing streams was contained in the less than 11 μm size fraction, with the flotation tails cyclones concentrating ˜60% of the total gold in the cyclone feed into the overflow.

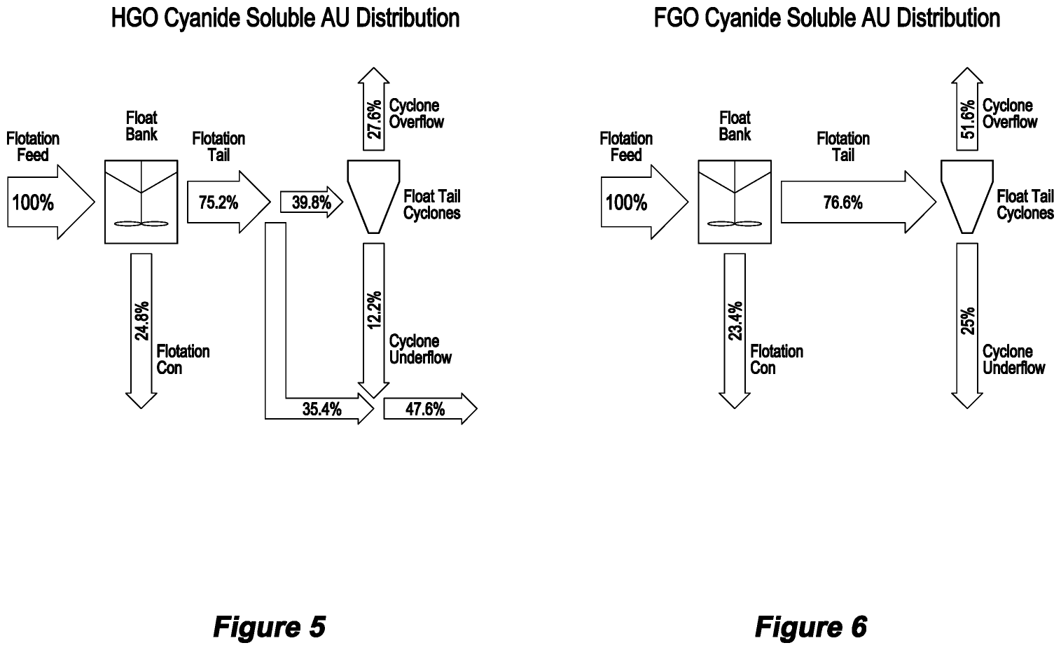

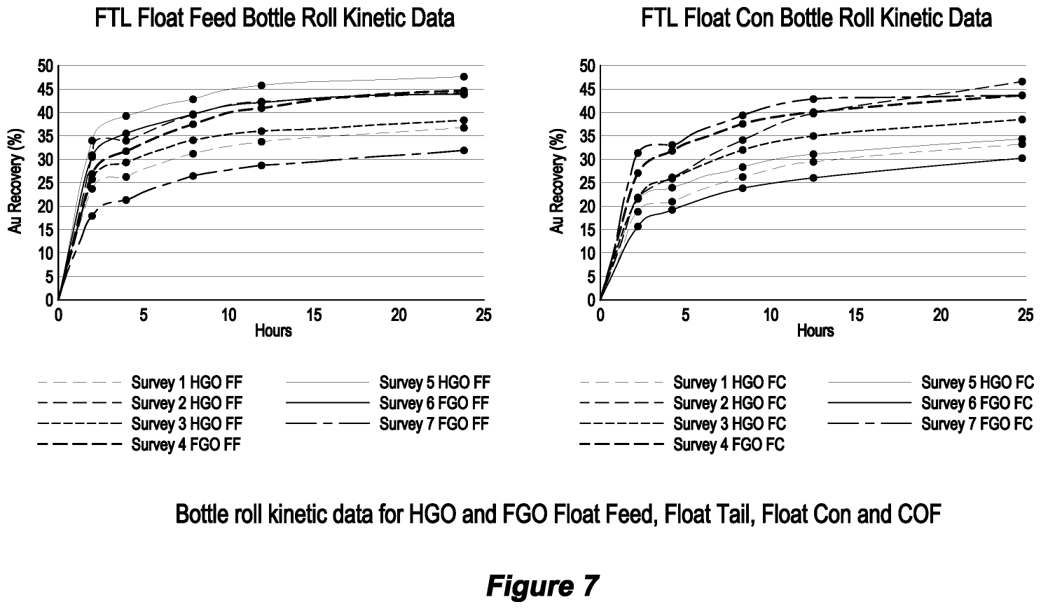

Cyanide soluble gold distributions for the HGO and FGO circuits are shown in FIG. 5 and FIG. 6.

It is clear from these Figures that most of the free milling gold in the flotation tailing streams to the cyclones was in the overflow. For example, with reference to FIG. 6, the free milling gold in the flotation tailing stream to the cyclones in the FGO circuit split as follows-51.6% of the total 76.6% supplied to the cyclones was in the overflow and 25% of the total 76.6% supplied to the cyclones was in the underflow.

It is also clear from these Figures and from Table 3 below that the flotation tails for both the HGO and FGO circuits showed an enrichment of fast leaching gold, i.e. leached within 2 hours, relative to the flotation feed with a corresponding relative decrease in the flotation concentrate.

TABLE 3
Percentage of total CN Sol Au leached in the
first 2 hrs in the float and cyclone circuits

| | % of total CN Sol Au | |
|---|---|---|
| | leached in the first 2 hrs | Change relative to Feed |
| Float Feed | 66% | 0% |
| Float Con | 57% | 86% |
| Float Tail | 80% | 121% |
| FTL COF | 84% | 127% |

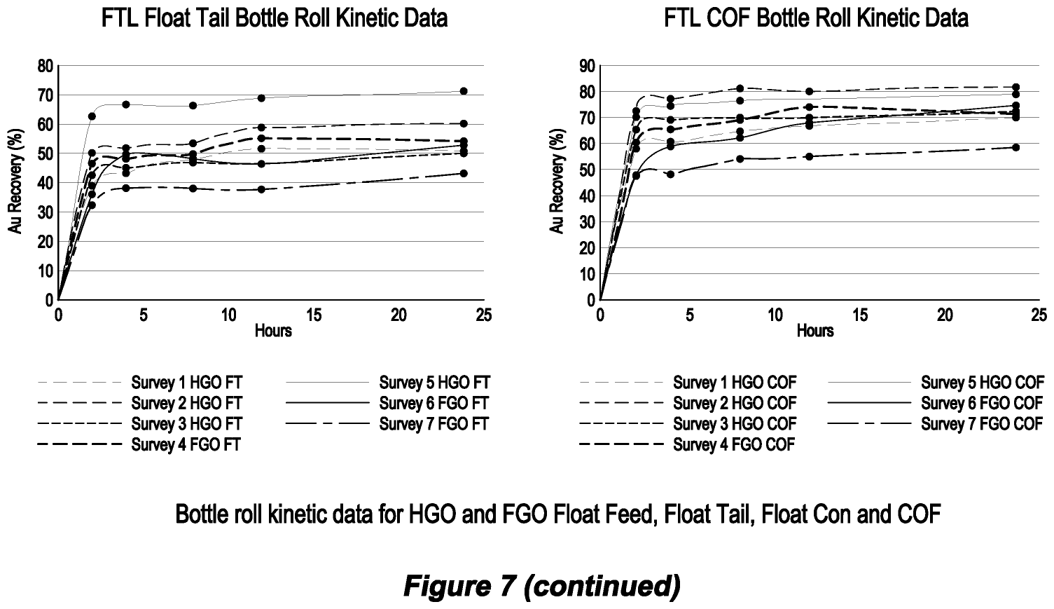

This was also seen in the bottle roll kinetic data (FIG. 7) with the float tails and cyclone overflow curves being relatively flat beyond 2 hours. This suggests that there were no kinetic limitations on the leaching of the gold in the cyclone overflow in the downstream gold recovery CIL circuits.

The cyclone circuits exhibited stability during the surveying period with the cyclone overflows having a relatively constant P80 of ˜43 μm and cyanide soluble gold content of ˜74%.

It is evident from the above that there is significant cyanide soluble gold in the HGO and FGO flotation tailing streams that can be recovered.

Both the HGO and FGO circuits performed better than design specifications with ˜30% more gold recovered from the flotation tails than predicted in the design specifications.

During the surveying period, ˜356 kt of material was milled at a grade of 2.38 g/t Au with ˜93% of this being fed to the flotation circuit.

It was found that the plant recovery contribution was 4.06%. This is a significant result and indicates that the FIG. 1 embodiment of the invention is a viable commercial opportunity.

### Example 2

### Performance Testing

The applicant carried out confidential performance testing of the embodiment of the invention shown in FIG. 2 at its Lihir mine in PNG.

As noted above, in the FIG. 2 embodiment, the coarse stream 15 from the cyclone 11 is transferred to and processed first in the second cyclone 37 to remove residual fine (i.e. <100 μm) material for processing in the leach circuit. The fines-deficient underflow stream 39 from the second cyclone 37 is transferred to and processed in the coarse flotation circuit 41, such as an Eriez Hydrofloat circuit, and the coarse concentrate stream 47 (containing gold-containing particles) is transferred to and processed in the regrind circuit 49, the cleaner flotation circuit 51 and the grind thickener 27. The resultant concentrate stream is processed in the autoclaves 25.

A 6-week confidential pilot plant campaign was run at the Lihir mine, with particular focus on testing performance of a coarse flotation circuit, specifically a Hydrofloat circuit, on the underflow of the (CUF) FTL cyclones. These FTL cyclones process flotation tails and concentrate fine cyanide soluble, free milling gold into the cyclone overflow (COF). The pilot plant campaign also evaluated performance of downstream processing of a coarse concentrate stream from the Hydrofloat circuit.

The same sample analysis and test work described above in relation to Example 1 was carried out on samples collected during the pilot plant campaign.

Results from the pilot plant campaign are summarised below:
The Hydrofloat circuit achieved good recoveries, high mass pull due to sulphur in tails, and liberation (floating down to 5% liberation)
The downstream regrind+cleaning steps
Similar response at regrinds between P80 53 μm and 106 μm.
The single stage cleaner had low S2=in the final concentrate.

The Hydrofloat circuit recovered an additional 4.7% of the gold from the flotation feed. After re-grind and cleaning, this dropped to 3.8% (cleaner stage recovery of ˜80%).

Overall flotation concentrates mass recovery increased by 2.9%, lifting from 37.7% to 40.6%.

The flotation recovery by size relationship was significantly extended with improved recovery in all size fractions greater than 75 μm. The +212 μm and +300 μm size fractions showed the largest improvements with recovery of gold from flotation feed increasing by 33% and 35%, respectively.

The maximum difference between the parity line and the gold recovery curve was achieved at 30% mass pull in the Hydrofloat circuit with 55% of the gold in Hydrofloat circuit feed being recovered. At 30% mass pull to the Hydrofloat circuit concentrate, 60% of the sulphide sulphur in Hydrofloat circuit feed was recovered.

The pilot plant results are significant and indicate that the FIG. 2 embodiment of the invention is a viable commercial opportunity.

Many modifications may be made to the embodiments of the invention described above without departing from the spirit and scope of the invention.

1-24. (canceled)

25. A method of recovering free milling gold from a gold-containing feed material, the method comprising:
(a) passing a feed stream of the gold-containing feed material through a flotation element and producing (i) a concentrate stream and (ii) a tailings stream;
(b) processing at least a part of the tailings stream in a size separation element, and producing a fines stream and a coarse stream; and
(c) recovering free milling gold from the fines stream.

26. The method according to claim 25, wherein (b) comprises processing the at least part of the tailings stream in a size separation element to produce the fines stream and the coarse stream, with a threshold particle size below which particles are in the fines stream and above which particles are in the coarse stream, the threshold particle size being selected so that a substantial amount of free milling gold in the processed tailings stream is in the fines stream.

27. The method according to claim 26, wherein up to 20% by weight of particles that are larger in size than the threshold particle size is in the fines stream.

28. The method according to claim 26, wherein up to 20% by weight of particles that are smaller in size than the threshold particle size are in the coarse stream.

29. The method according to claim 26, further comprising:
taking measurements of concentrations of free milling gold in the fines stream and the coarse stream; and
adjusting the threshold particle size during the method, guided by the measurements.

30. The method according to claim 26, wherein the substantial amount of free milling gold is at least 55 wt. % of the total of the free milling gold in the processed tailings stream.

31. The method according to claim 25, wherein (c) comprises:
(i) recovering free milling gold from the fines stream by leaching the stream with a lixiviant and taking free milling gold into a solution; and
(ii) recovering free milling gold from the solution.

32. The method according to claim 25, further comprising processing the coarse stream produced in (b) in another size separation element and producing a fines stream and a coarse stream.

33. The method according to claim 32, further comprising recovering free milling gold from the fines stream from the other fines separation element.

34. The method according to claim 33, further comprising processing the coarse stream from the other fines separation element in a coarse flotation element and producing a coarse concentrate stream and a tailings stream.

35. The method according to claim 34, further comprising grinding the coarse concentrate stream and producing a ground concentrate stream.

36. The method according to claim 35, further comprising processing the ground concentrate stream in a cleaner element and producing (i) another concentrate stream and (ii) a tailings stream.

37. The method according to claim 36, further comprising recovering gold from the other concentrate stream.

38. The method according to claim 32, further comprising processing the coarse stream produced in (b) in a re-grind circuit and a single stage cleaning circuit and producing another concentrate stream.

39. The method according to claim 38, further comprising recovering gold from the other concentrate stream.

40. A plant for recovering cyanide soluble gold from a gold-containing feed material, the plant comprising:
(a) a flotation element operable to produce (i) a concentrate stream and (ii) a tailings stream from a feed material; and
(b) a size separation element operable to process the tailings stream and produce a fines stream and a coarse stream; and
(c) a recovery unit operable to recover free milling gold from the fines stream.

41. The plant according to claim 40, further comprising a comminution circuit operable to produce the feed material for the flotation element.

42. The plant according to claim 40, wherein the size separation element comprises cyclones.

43. The plant according to claim 40, further comprising another size separation element operable to process the coarse stream from size separation element (b) and produce a fines stream and a coarse stream.

44. The plant according to claim 43, further comprising a coarse flotation element operable to process the coarse stream from the other size separation element and produce a coarse concentrate stream and a tailings stream.
